(19) United States
(12) Patent Application Publication
(10) Pub. No.: US 2026/0023370 A1
(43) Pub. Date: Jan. 22, 2026

(54) PROCESSING SYSTEM, SUBSTRATE PROCESSING APPARATUS, PROCESSING METHOD, METHOD OF MANUFACTURING SEMICONDUCTOR DEVICE AND NON-TRANSITORY COMPUTER-READABLE RECORDING MEDIUM

(71) Applicant: Kokusai Electric Corporation, Tokyo (JP)

(72) Inventor: Ryosuke KAMEDA, Toyama (JP)

(73) Assignee: Kokusai Electric Corporation, Tokyo (JP)

(21) Appl. No.: 19/271,875

(22) Filed: Jul. 17, 2025

(30) Foreign Application Priority Data
Jul. 18, 2024 (JP) 2024-115066

(51) Int. Cl. G05B 19/418

(52) U.S. Cl. CPC G05B 19/4187; G05B 19/4183; G05B 2219/33004; G05B 2219/37333; G05B 2219/45031

(57) ABSTRACT

It is possible to recognize the consistency of opening/closing states of valves to be affected by a valve when the valve is set to be open. There is provided a technique that includes: a display structure by which a recipe defining process conditions is editable, wherein a display area includes a valve opening/closing setting area configured to set opening/closing states of valves connected to a piping; and a controller for: (a) when at least one specified valve among the valves is set to be open, checking opening/closing states of one or more related valves which are to be affected by the specified valve set to be open; and (b) when the opening/closing states of the related valves are different from predefined opening/closing states, switching a display of each related valve whose opening/closing state is different from a corresponding one of the predefined opening/closing states in the valve opening/closing setting area.

### CROSS-REFERENCE TO RELATED PATENT APPLICATION

This non-provisional U.S. patent application is based on and claims priority under 35 U.S.C. § 119 of Japanese Patent Application No. 2024-115066, filed on Jul. 18, 2024, in the Japanese Patent Office, the entire contents of which are here by incorporated by reference.

### BACKGROUND

### 1. Field

The present disclosure relates to a processing system, a substrate processing apparatus, a processing method, a method of manufacturing a semiconductor device and a non-transitory computer-readable recording medium.

### 2. Related Art

According to some related arts, a substrate processing apparatus provided with a display is used. For example, the display may be provided with buttons for comparing parameters indicating contents of a valve interlock check with each valve set in a recipe for processing a substrate.

### SUMMARY

According to the present disclosure, there is provided a technique capable of recognizing the consistency of opening/closing states of one or more valves which are affected by a valve when the valve is set to be open.

According to an embodiment of the present disclosure, there is provided a technique that includes: a display structure provided with a display area in which a recipe defining process conditions for a substrate is editable, wherein the display area includes a valve opening/closing setting area configured to set opening/closing states of a plurality of valves connected to a piping through which a fluid used in processing the substrate flows; and a controller configured to be capable of: (a) when at least one specified valve among the plurality of valves is set to be open, checking opening/closing states of one or more related valves among the plurality of valves which are to be affected by the specified valve set to be open; and (b) when the opening/closing states of the related valves are different from predefined opening/closing states, switching a display of each related valve whose opening/closing state is different from a corresponding one of the predefined opening/closing states in the valve opening/closing setting area.

### BRIEF DESCRIPTION OF THE DRAWINGS

FIG. 1 is a diagram schematically illustrating a perspective view of an example of a substrate processing apparatus according to one or more embodiments of the present disclosure.

FIG. 2 is a diagram schematically illustrating a cross-section of the substrate processing apparatus according to the embodiments of the present disclosure when viewed from side.

FIG. 3 is a block diagram schematically illustrating an example of a functional configuration of a control apparatus and related components of the substrate processing apparatus according to the embodiments of the present disclosure.

FIG. 4 is a diagram schematically illustrating an example of a recipe setting screen according to the embodiments of the present disclosure.

FIG. 5 is a diagram schematically illustrating an example of a valve opening/closing setting area according to the embodiments of the present disclosure.

FIG. 6 is a diagram schematically illustrating an example of a check area according to the embodiments of the present disclosure.

FIG. 7 is a diagram schematically illustrating an example of the valve opening/closing setting area when a valve setting shown in FIG. 5 is changed.

FIG. 8 is a flow chart schematically illustrating a valve opening/closing setting process.

FIG. 9 is a flow chart schematically illustrating a valve interlock check process.

FIG. 10 is a diagram schematically illustrating valve parameters.

### DETAILED DESCRIPTION

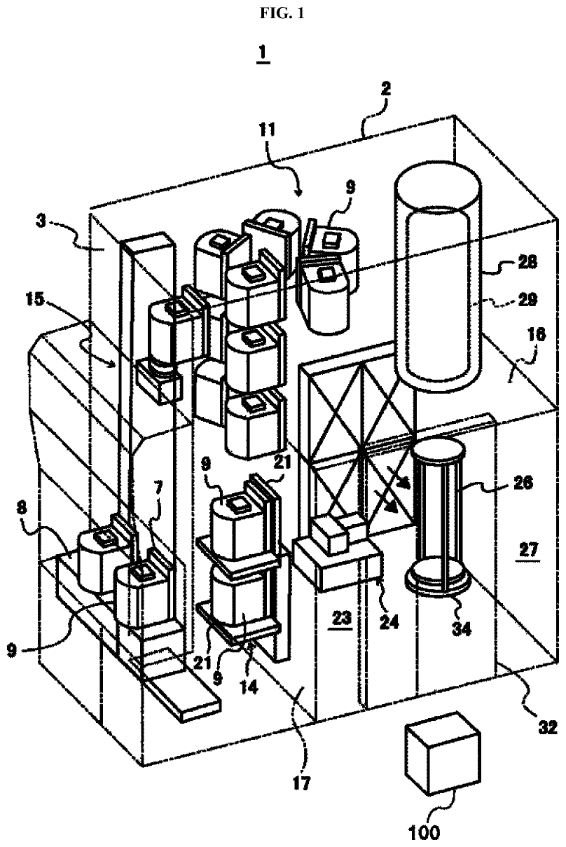

Hereinafter, one or more embodiments (also simply referred to as “embodiments”) according to the technique of the present disclosure will be described mainly with reference to FIGS. 1 to 3. The drawings used in the following descriptions are all schematic. For example, a relationship between dimensions of each component and a ratio of each component shown in the drawing may not always match the actual ones. Further, even between the drawings, the relationship between the dimensions of each component and the ratio of each component may not always match. In addition, the technique of the present disclosure is not limited to the embodiments described below. That is, the technique of the present disclosure may be appropriately modified in various ways without departing from the scope thereof.

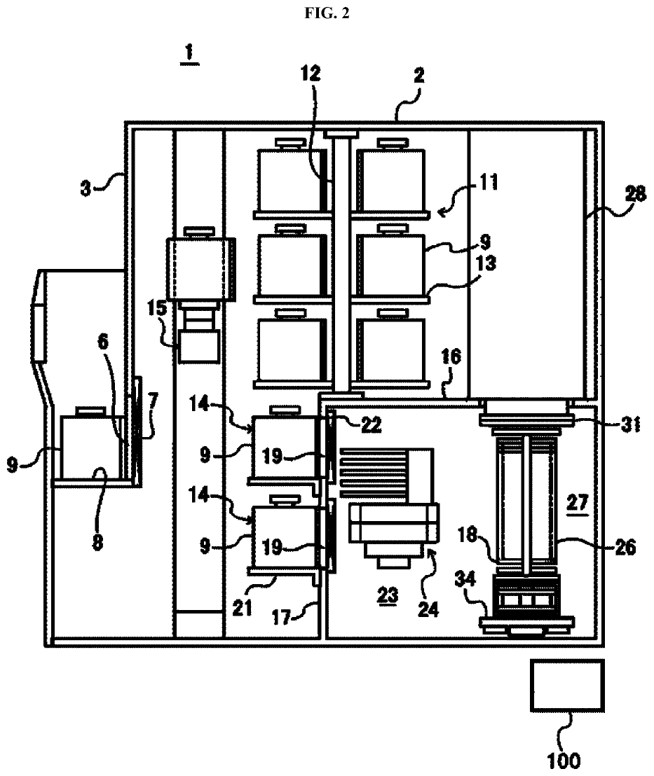

First, with reference to FIGS. 1 and 2, an outline of a substrate processing apparatus 1 according to the present embodiments will be described.

FIG. 1 is a diagram schematically illustrating a perspective view of an example of the substrate processing apparatus 1 according to the present embodiments, and FIG. 2 is a diagram schematically illustrating a cross-section of the substrate processing apparatus 1 according to the present embodiments when viewed from side. In FIGS. 1 and 2, a vertical type substrate processing apparatus is shown as an example of the substrate processing apparatus 1, and a semiconductor wafer made of a material such as silicon is shown as an example of a substrate (that is, a wafer 18 described later) to be processed in the substrate processing apparatus 1. In the present specification, the term “wafer” may refer to “a wafer itself”, or may refer to “a wafer and a stacked structure (aggregated structure) of a predetermined layer (or layers) or a film (or films) formed on a surface of the wafer”. In the present specification, the term “a surface of a wafer” may refer to “a surface of a wafer itself”, or may refer to “a surface of a predetermined layer (or a predetermined film) formed on a wafer”. Thus, in the present specification, the term “forming a predetermined layer (or a film) on a wafer” may refer to “forming a predetermined layer (or a film) directly on a surface of a wafer itself”, or may refer to “forming a predetermined layer (or a film) on a surface of another layer (or another film) formed on a wafer”. In the present specification, the terms “substrate” and “wafer” may be used as substantially the same meaning.

As shown in FIGS. 1 and 2, the substrate processing apparatus 1 includes a housing 2. A pod loading/unloading port 6 is provided at a front wall 3 of the housing 2 so as to communicate between an inside (inner portion) and an outside (outer portion) of the housing 2. The pod loading/unloading port 6 can be opened or closed by a front shutter (which is a pod loading/unloading port opening/closing structure) 7. A loading port (which is a loading port shelf, that is, a transfer table for a substrate transfer container) 8 is provided in front of the pod loading/unloading port 6.

For example, a pod 9 is configured as a sealed type substrate transfer container. The pod 9 may be transferred (loaded) into and placed on the loading port 8 by an in-process transfer apparatus (not shown) and may be transferred (unloaded) out of the loading port 8 by the in-process transfer apparatus.

A rotatable pod shelf (which is a storage shelf for the substrate transfer container) 11 is provided in the housing 2 to be located over a substantially center portion of the housing 2 in a front-rear direction. The rotatable pod shelf 11 is configured such that a plurality of pods including the pod 9 can be stored (or placed) on the rotatable pod shelf 11. Hereinafter, the plurality of pods including the pod 9 may also be simply referred to as “pods 9”. The rotatable pod shelf 11 includes a plurality of shelf plates (which are placement shelves for the substrate transfer container) 13 arranged in a multistage manner. Each of the plurality of shelf plates 13 is configured to accommodate at least one among the pods 9.

A pod opener (which is a structure capable of opening and closing a lid of the substrate transfer container) 14 is provided below the rotatable pod shelf 11. The pod opener 14 is provided with a configuration on which the pod 9 is placed and capable of opening and closing a lid of the pod 9.

A pod transfer structure (which is a container transfer structure) 15 is provided among the loading port 8, the rotatable pod shelf 11 and the pod opener 14. The pod transfer structure 15 is configured such that the pod 9 can be transferred among the loading port 8, the rotatable pod shelf 11 and the pod opener 14.

A sub-housing 16 is provided below the substantially center portion of the housing 2 in the front-rear direction to extend toward a rear end of the substrate processing apparatus 1. A pair of wafer loading/unloading ports (substrate loading/unloading ports) 19 through which the wafer 18 serving as the substrate is loaded into or unloaded out of the sub-housing 16 is provided at a front wall 17 of the sub-housing 16.

The pod opener 14 includes: a placement table 21 where the pod 9 is placed thereon; and an attaching/detaching structure 22 capable of attaching and detaching the lid of the pod 9. The pod opener 14 is configured such that a wafer entrance of the pod 9 is opened or closed by detaching or attaching the lid of the pod 9 placed on the placement table 21 by the attaching/detaching structure 22.

The sub-housing 16 defines a transfer chamber 23 fluidically isolated from a space (hereinafter, also referred to as a “pod transfer space”) in which the pod transfer structure 15 or the rotatable pod shelf 11 is provided. A wafer transfer structure (which is a substrate transfer structure) 24 is provided at a front region of the transfer chamber 23. A predetermined number of wafers (for example, as shown in FIG. 2, five wafers) placed on the wafer transfer structure 24 can be moved linearly in a horizontal direction, can be rotated in the horizontal direction and can be elevated or lowered in a vertical direction. The wafer transfer structure 24 is configured such that the wafer 18 can be loaded into or unloaded out of a boat (which is a substrate retainer) 26.

In a rear region of the transfer chamber 23, a standby space 27 where the boat 26 is accommodated in standby is provided, and a process furnace 28 such as a vertical type process furnace is provided above the standby space 27. In addition, a process chamber 29 in which the wafer 18 is processed is provided. The process chamber 29 may also be referred to as a “process vessel” which is an example of a processing structure.

Subsequently, an operation of the substrate processing apparatus 1 will be described.

When the pod 9 is supplied to the loading port 8, the pod loading/unloading port 6 is opened by the front shutter 7. Then, the pod 9 placed on the loading port 8 is transferred (loaded) into the housing 2 through the pod loading/unloading port 6 by the pod transfer structure 15, and is placed on a designated shelf plate among the plurality of shelf plates 13 of the rotatable pod shelf 11. The pod 9 is temporarily stored in the rotatable pod shelf 11. Then, the pod 9 is transferred from the designated shelf plate among the plurality of shelf plates 13 to the pod opener 14 and the placement table 21. Alternatively, the pod 9 may be transferred directly from the loading port 8 to the placement table 21.

When an end surface of the pod 9 placed on the placement table 21 is pressed against an opening edge of the wafer loading/unloading port 19 of the front wall 17 of the sub-housing 16, the attaching/detaching structure 22 detaches the lid of the pod 9 and the wafer entrance of the pod 9 is opened.

When the pod 9 is opened by the pod opener 14, the wafer 18 is then taken out from the pod 9 by the wafer transfer structure 24. Then, by the wafer transfer structure 24, the wafer 18 is transferred (or loaded) into the standby space 27, and loaded (or charged) into the boat 26.

When a predetermined number of wafers including the wafer 18 are charged into the boat 26, a furnace opening of the process furnace 28 closed by a furnace opening shutter 31 is opened by the furnace opening shutter 31. Subsequently, the boat 26 is elevated by a boat elevator 32 such that the boat 26 is loaded (inserted) into the process chamber 29.

After the boat 26 is loaded, the furnace opening is airtightly closed by a seal cap 34. Further, according to the present embodiments, at this timing (that is, after the boat 26 is loaded), a purge step (also referred to as a “pre-purge step”) of replacing an inner atmosphere of the process chamber 29 with an inert gas may be performed.

The process chamber 29 is vacuum-exhausted by a vacuum pump (not shown) such that a pressure (inner pressure) of the process chamber 29 reaches and is maintained at a desired pressure (vacuum degree). Further, the process chamber 29 is heated to a predetermined temperature by a heater (not shown) such that a desired temperature distribution of the process chamber 29 is obtained.

Further, a process gas is supplied from a process gas supply source (not shown). That is, the process gas whose flow rate is controlled to a predetermined flow rate is supplied. The process gas comes into contact with a surface of the wafer 18 while flowing through the process chamber 29. Thereby, a predetermined processing such as a substrate processing described later is performed on the surface of the wafer 18. In addition, the process gas after a reaction of the predetermined processing is exhausted from the process chamber 29 by a gas exhaust structure (which is a gas exhauster) (not shown). In the present specification, the term “process gas” refers to a gas supplied into the process chamber 29. The same also applies to the following description.

After a predetermined process time has elapsed, the inert gas is supplied from an inert gas supply source (not shown). Thereby, the inner atmosphere of the process chamber 29 is replaced with the inert gas, and the inner pressure of the process chamber 29 is returned to a normal pressure (after-purge step). Then, the boat 26 is lowered by the boat elevator 32 through the seal cap 34. In the present specification, the term “process time” refers to a time duration of continuously performing a process related thereto. The same also applies to the following description.

After the wafer 18 is processed, the wafer 18 and the pod 9 are transferred (unloaded) out of the housing 2 in an order reverse to that of loading the wafer 18 and the pod 9 into the housing 2 described above. Then, another wafer (which is unprocessed) 18 is further loaded into the boat 26, and a batch processing for another wafer 18 is repeatedly performed. For example, the pod 9 accommodating the wafer 18 (which is processed) may be temporarily placed on the rotatable pod shelf 11, then transferred from the designated shelf plate among the plurality of shelf plates 13 to the loading port 8 by the pod transfer structure 15, and then transferred to the outside of the housing 2.

According to the present embodiments, as shown in FIGS. 1 and 2, the substrate processing apparatus 1 includes a control apparatus (which is a control structure) 100, and the control apparatus 100 is configured to control the substrate processing apparatus 1. The control apparatus 100 may be provided (embedded) in the substrate processing apparatus 1, or may be provided outside the substrate processing apparatus 1 in a manner accessible thereto.

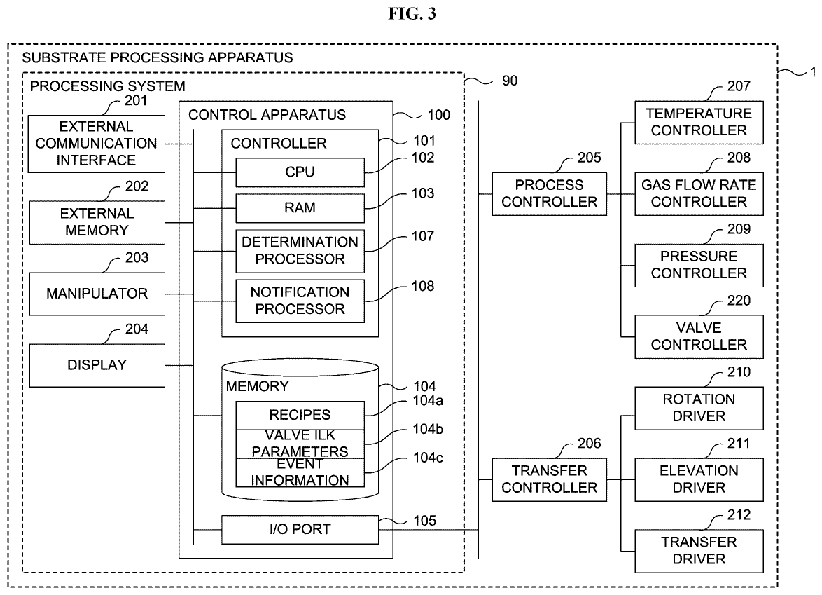

Subsequently, with reference to FIG. 3, a configuration of a control system of the substrate processing apparatus 1 according to the present embodiments will be described. FIG. 3 is a block diagram schematically illustrating an example of a functional configuration of the control apparatus 100 of the substrate processing apparatus 1 according to the present embodiments.

As shown in FIG. 3, the substrate processing apparatus 1 includes the control apparatus (which is a main controller or a primary controller) 100, an external communication interface 201, an external memory 202, a manipulator 203, a display (which is a display structure) 204, a process controller 205 and a transfer controller 206.

For example, the control apparatus 100 includes a controller 101, a memory 104 and an I/O port (input/output port) 105. In addition, the controller 101 includes a CPU (Central Processing Unit) 102, a RAM (Random Access Memory) 103, a determination processor 107 and a notification processor 108. In addition, while the determination processor 107 is illustrated as a function of the controller 101, the determination processor 107 may be implemented separately from the controller 101.

The control apparatus 100 is connected to the manipulator 203, and also connected to the process controller 205 and the transfer controller 206 via the I/O port 105. Since the control apparatus 100 is electrically connected to each of the process controller 205 and the transfer controller 206 via the I/O port 105, for example, each piece of data can be transmitted or received and each file can be downloaded or uploaded between the control apparatus 100 and each of the process controller 205 and the transfer controller 206.

The control apparatus 100 is connected to an external host computer (not shown) via the external communication interface 201. Therefore, even when the substrate processing apparatus 1 is installed in a clean room, the host computer can be disposed at a location such as an office outside the clean room. In addition, the external memory 202 (which serves as a mounting structure on which a recording medium such as a USB (Universal Serial Bus) memory is installed or removed) is connected to the control apparatus 100.

For example, the manipulator 203 is implemented by a configuration which is integrated with the display 204 as a single structure or which is connected to the display 204 via a connector such as a video cable. For example, the display 204 is configured as a liquid crystal display panel. Various operation screens for operating the substrate processing apparatus 1 can be displayed on the display 204. For example, the operation screen may include a screen through which a state of a substrate process system controlled by the process controller 205 and a state of a substrate transfer system controlled by the transfer controller 206 can be checked (or confirmed). The display 204 may be provided with various operation buttons serving as an input interface through which an operation instruction can be input via the manipulator 203 to the substrate process system and the substrate transfer system. The manipulator 203 displays information generated in the substrate processing apparatus 1 on the display 204 via the operation screen. For example, the manipulator 203 outputs the information displayed on the display 204 to a device such as the USB memory inserted in the external memory 202. The manipulator 203 accepts (or receives) input data (input instruction) from the operation screen displayed on the display 204 and transmits the input data to the control apparatus 100. Further, the manipulator 203 is configured to receive an instruction (control instruction) to execute an appropriate substrate processing recipe (also referred to as a “process recipe”) among recipes expanded in the RAM 103 or recipes (that is, recipes 104a) stored in the memory 104, and is further configured to transmit the instruction to the control apparatus 100. For example, the manipulator 203 and the display 204 may be configured as a touch panel. According to the present embodiments, the manipulator 203 and the display 204 are provided separately from the control apparatus 100. However, the manipulator 203, the display 204 and the control apparatus 100 may be integrated into a single structure.

The process controller 205 includes a temperature controller 207, a gas flow rate controller 208, a pressure controller 209 and a valve controller 220. Each of the temperature controller 207, the gas flow rate controller 208, the pressure controller 209 and the valve controller 220 constitutes a sub-controller, and is electrically connected to the process controller 205. Thereby, for example, each piece of data can be transmitted or received and each file can be downloaded or uploaded between the process controller 205 and each sub-controller. In addition, while the process controller 205 and each sub-controller (that is, the temperature controller 207, the gas flow rate controller 208, the pressure controller 209 and the valve controller 220) are illustrated separately, the process controller 205 and each sub-controller may be integrated into a single structure.

The temperature controller 207 is configured to control a process temperature based on measured values detected by a temperature sensor (not shown). Specifically, the temperature controller 207 is configured to adjust a temperature (inner temperature) of the process chamber 29 or a temperature of the wafer 18 by controlling a temperature of the heater (not shown). In the present specification, the term “process temperature” refers to the temperature of the wafer 18 or the inner temperature of the process chamber 29.

The gas flow rate controller 208 is configured to adjust a flow rate of the gas (which is supplied into the process chamber 29) to a desired flow rate based on measured values detected by a gas flow rate sensor (not shown).

The pressure controller 209 is configured to control a process pressure based on pressure values detected by a pressure sensor (not shown). Specifically, the pressure controller 209 is configured to control a switching operation (on/off operation) of a pressure regulator (which is a pressure adjusting structure) and a switching operation of the vacuum pump (not shown) such that the inner pressure of the process chamber 29 reaches and is maintained at a desired pressure at a desired timing. In the present specification, the term “process pressure” refers to the inner pressure of the process chamber 29.

The valve controller 220 is configured to control opening and closing operations of valves in accordance with states of the valves set in the recipe.

The transfer controller 206 includes a rotation driver 210, an elevation driver 211 and a transfer driver 212. In addition, while the transfer controller 206, the rotation driver 210, the elevation driver 211 and the transfer driver 212 are illustrated separately, the transfer controller 206, the rotation driver 210, the elevation driver 211 and the transfer driver 212 may be integrated into a single structure. The rotation driver 210 is configured to control a rotation drive system of the substrate processing apparatus 1. For example, the rotation drive system is constituted by the pod transfer structure 15, the wafer transfer structure 24, a rotating shaft 12 disposed at a center of the rotatable pod shelf 11 and a rotator (which is a rotating structure) (not shown). The rotation driver 210 is configured to control an operation of the rotation drive system based on measured values of a position sensor (not shown) and a torque sensor (not shown).

The elevation driver 211 is configured to control an elevation drive system of the substrate processing apparatus 1. The elevation driver 211 is configured to control an operation of the elevation drive system based on measured values of a position sensor (not shown) and a torque sensor (not shown). The transfer driver 212 is configured to control a transfer drive system of the substrate processing apparatus 1. The transfer driver 212 is configured to control an operation of the transfer drive system based on measured values of a position sensor (not shown) and a torque sensor (not shown). For example, each of the elevation driver 211 and the transfer driver 212 is configured to control transfer operations of the boat elevator 32, the pod transfer structure 15 and the wafer transfer structure 24.

Further, in the present embodiments, each temperature sensor, each gas flow rate sensor, each pressure sensor, each position sensor and each torque sensor may be collectively referred to as “various sensors provided in the substrate processing apparatus 1”, or may be simply referred to as “sensors”.

In addition, according to the present embodiments, each of the control apparatus 100, the process controller 205 and the transfer controller 206 may be embodied by a general computer system instead of a dedicated computer system. For example, by installing, in the general computer system, a program for executing the predetermined processing described above from a predetermined recording medium such as a CD-ROM and a USB memory storing the program, each controller described above may be provided to perform the predetermined processing.

Further, a method of supplying the program described above can be appropriately selected. Instead of or in addition to being supplied through the predetermined recording medium as described above, for example, the program may be provided through a communication interface such as a communication line, a communication network and a communication system.

Further, the control apparatus 100 is configured as a computer including the CPU 102, the RAM 103, the memory 104 and the I/O port 105. In the memory 104, a recipe file such as a recipe in which process conditions and process procedures of the substrate processing are defined, a control program file for executing the recipe file, a parameter file (setting value file) in which parameters for setting the process conditions and the process procedures are defined, an error processing program file, a parameter file for an error processing, various screen files including an input screen to be used to input process parameters and various icon files and the like (which are not shown) are stored (or saved). For example, the control apparatus 100 is electrically connected to a network such as the Internet, a LAN (Local Area Network) and a WAN (Wide Area Network) by using the external communication interface 201, and is configured to be capable of communicating with external apparatuses via the network.

As the memory 104, for example, a component such as a hard disk drive (HDD), a solid state drive (SSD) and a flash memory may be used. In addition, in the memory 104, a valve interlock check processing program for executing a valve interlock check process according to the present embodiments is stored. In the following description, “interlock” may be abbreviated as “ILK” as appropriate.

For example, the valve interlock check processing program (valve ILK check processing program) may be installed in advance in the substrate processing apparatus 1. The valve interlock check processing program may be implemented by appropriately installing the valve interlock check processing program (which may be recorded on a non-volatile recording medium or distributed via the network) in the substrate processing apparatus 1. As the non-volatile recording medium, for example, a component such as a CD-ROM, a magneto-optical disk, a HDD, a DVD-ROM, a flash memory, a memory card and a USB memory may be used.

In other words, the valve interlock check processing program is a program that causes the substrate processing apparatus 1, by a computer, to perform: (a) editing the recipe in which the process conditions for the substrate (that is, the wafer 18) are defined; and (b) processing the substrate using the recipe edited in (a).

The CPU 102 of the substrate processing apparatus 1 according to the present embodiments functions as the controller 101 (which includes the determination processor 107 and the notification processor 108), by writing the valve interlock check processing program stored in the memory 104 to the RAM 103 and executing the valve interlock check processing program.

The substrate processing apparatus 1 according to the present embodiments includes the process furnace 28 serving as the process vessel and a processing system 90.

The process furnace 28 is configured to process the substrate (that is, the wafer 18) based on the recipe in which the process conditions for the substrate are defined. That is, the substrate is processed in the process furnace 28.

The processing system 90 is configured to perform a setting operation for the recipe. For example, the setting operation for the recipe includes an editing operation for the recipe. The processing system 90 includes the control apparatus 100 and the display 204.

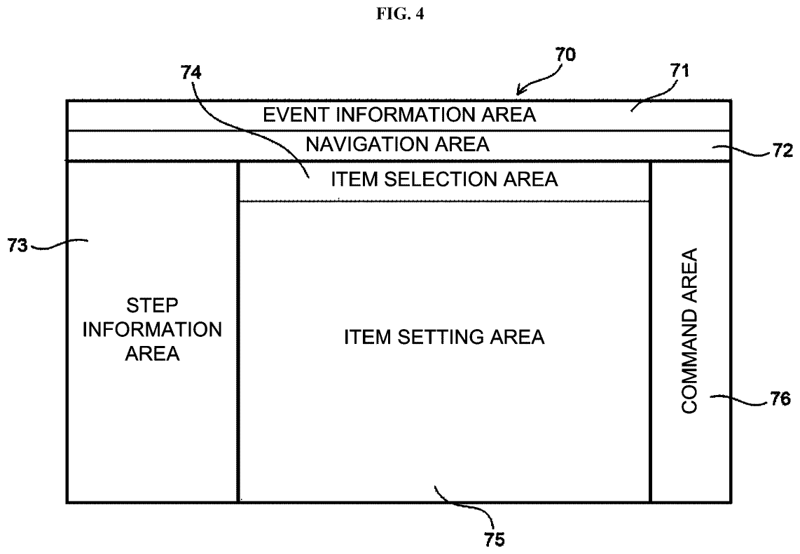

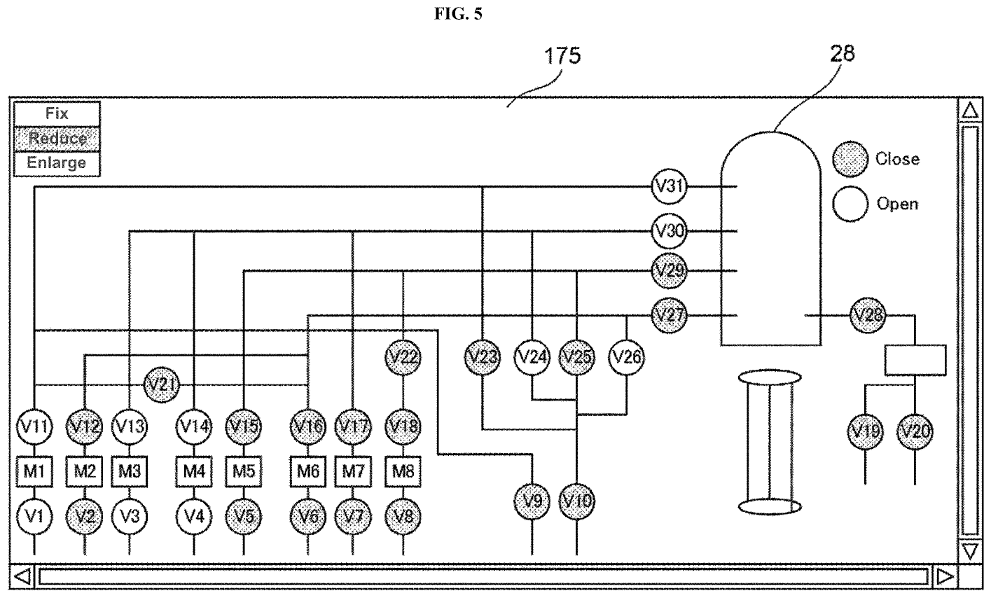

An example of a valve opening/closing setting operation according to the present embodiments will be described in detail with reference to FIGS. 4 and 5. FIG. 4 is a diagram schematically illustrating an example of a recipe setting screen 70 according to the present embodiments, and FIG. 5 is a diagram schematically illustrating an example of a valve opening/closing setting area 175 on the recipe setting screen 70 according to the present embodiments.

The recipe setting screen 70 shown in FIG. 4 includes an event information area 71, a navigation area 72, a step information area 73, an item selection area 74, an item setting area 75 and a command area 76.

In the event information area 71, for example, events of the substrate processing apparatus 1 are displayed. Specifically, the latest event is displayed in the event information area 71. In addition, a details button (not shown) is displayed in the event information area 71. When the details button is pressed (for example, by an operation such as a touch operation and a cursor operation), details of the latest event are displayed. In addition, a history list button (not shown) may be displayed in the event information area 71. When the history list button is pressed, a history of the events is displayed. For example, the events displayed in the event information area 71 are stored in the event information 104c of the memory 104, and the information stored in the event information 104c is read out and displayed.

In the step information area 73, a list of step information registered in the recipe is displayed. For example, the step information includes information such as a step number, a step process time for each step, a step name (ID) and a presence or absence of an execution command.

In the item selection area 74, items to be displayed in the item setting area 75 are displayed in a selectable manner. In the present specification, the term “items” (which can be set) are examples of setting items. For example, the items which are selectable (hereinafter, also referred to as “selectable items”) may include a temperature, the flow rate of the gas, a pressure, a transfer control (transfer structure) and the valves. Specifically, the item selection area 74 is provided with tabs corresponding to each of these items, and detailed settings for information regarding each item can be made by selecting a tab related thereto. In addition, in the item setting area 75, the selectable items are displayed such that they can be set by the manipulator 203.

For example, the items which can be set (that is, the setting items which can be set) are not limited to those exemplified above, and may be any items as long as they can define conditions related to the substrate processing in the substrate processing apparatus 1.

For example, when the tab related to the valves is selected in the item selection area 74, the valve opening/closing setting area 175 is displayed instead of the item setting area 75. That is, the entire valve opening/closing setting area 175 is displayed instead of the entire item setting area 75. However, the present embodiments are not limited thereto. For example, the valve opening/closing setting area 175 may serve as a part of the item setting area 75.

As shown in FIG. 5, the valve opening/closing setting area 175 is an area for setting information related to the valves provided in the process furnace 28. Specifically, in the valve opening/closing setting area 175, an opening/closing state (that is, an on/off state) of each valve is displayed. In addition, by operating each valve in the valve opening/closing setting area 175, it is possible to switch the opening/closing state of each valve. In other words, in the valve opening/closing setting area 175, it is possible to set the opening/closing state of each valve. The valve opening/closing setting area 175 will be described in detail later.

In the command area 76, for example, a plurality of buttons such as an “Esc” button (not shown) and a “Save” button (not shown) are displayed. For example, when the Esc button is pressed, an operation of closing the recipe setting screen 70 is performed. For example, when the Save button is pressed, an operation of saving (storing) contents edited on the recipe setting screen 70 is performed. For example, the contents of the recipe setting screen 70 may be stored in the memory 104 or in the external memory 202. By storing the recipe (which is edited) in a manner described above, it is possible to process the substrate (that is, the wafer 18) based on the recipe which is stored.

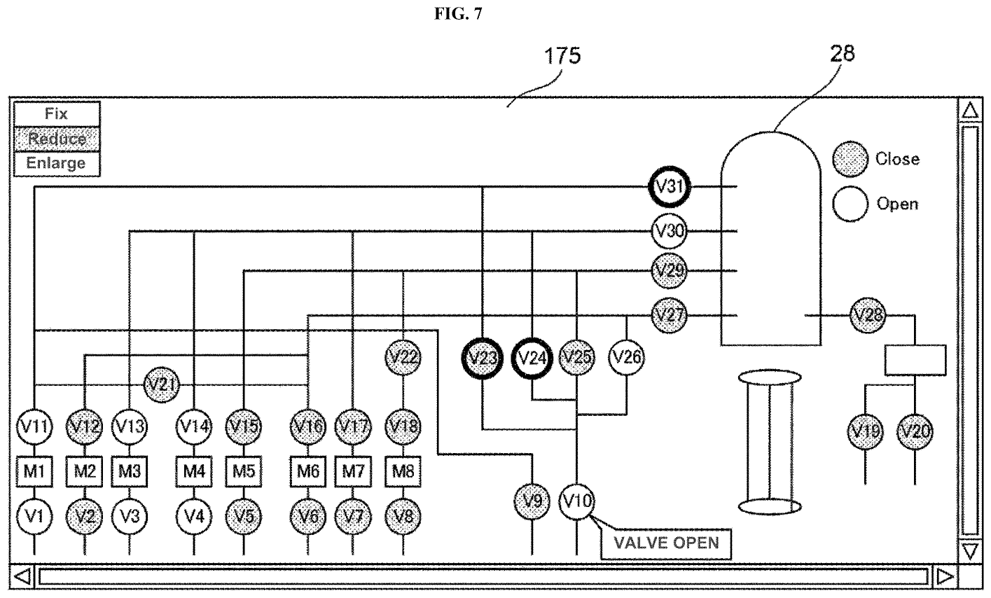

In the example shown in FIG. 5, in the valve opening/closing setting area 175, opening/closing states of valves V1 to V31 provided in the process furnace 28 are displayed. According to the present embodiments, when at least one among the valves V1 to V31 is set to be open, the controller 101 checks the opening/closing states of one or more related valves among the valves V1 to V31 (other than the valve set to be open as mentioned above) which are to be affected by the valve set to be open. When there is any difference between the opening/closing states of at least one of the related valves and predefined opening/closing states corresponding thereto, the controller 101 controls the valve opening/closing setting area 175 to switch a display of the at least one of the related valves whose opening/closing state is different from the predefined opening/closing state corresponding thereto. For example, when the valve V10 in a closed state is selected and then set to be open (that is, when the opening/closing state of the valve V10 is changed from the closed state to an open state), the controller 101 checks the opening/closing states of the valves V23, V24, V25, V26, V27 and V31 to be affected by the valve V10 set to be open. When the opening/closing states of the valves V23, V24, V25, V26, V27 and V31 differ from the predefined opening/closing states corresponding thereto, the controller 101 controls the valve opening/closing setting area 175 to switch the display of the valves V23, V24 and V31 (among the valves V23, V24, V25, V26, V27 and V31) whose opening/closing states are different from the predefined opening/closing states corresponding thereto, as shown in FIG. 7.

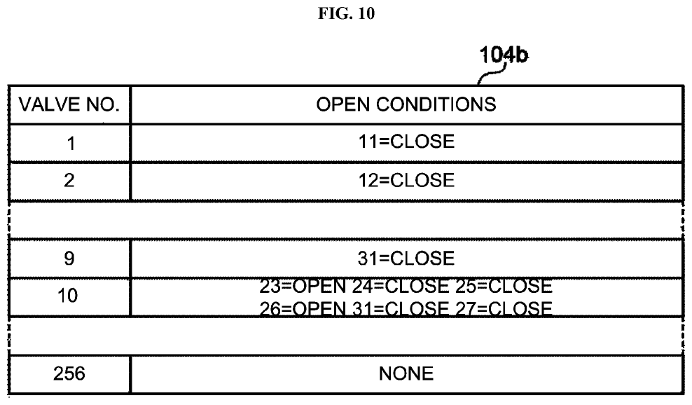

For example, the memory 104 stores valve interlock parameters (valve ILK parameters) 104b (hereinafter, also simply referred to as “parameters 104b”) that define the valve which is set to be open and the opening/closing states of the related valves which are to be affected by the valve set to be open (see FIG. 10). When the valve is set to be open, the controller 101 obtains the parameters 104b from the memory 104 and performs a control to determine a difference between the opening/closing states of the related valves displayed in the valve opening/closing setting area 175 and the opening/closing states of the related valves defined in the parameters 104b. The parameters 104b define the opening/closing state of each of the related valves to be affected by the valve set to be open.

The controller 101 controls the determination processor 107 to determine the difference between the opening/closing states of the related valves displayed in the valve opening/closing setting area 175 and the opening/closing states of the related valves defined in the parameters 104b, and causes the notification processor 108 to notify a determination result. Alternatively, the controller 101 controls the determination processor 107 to determine the difference between the opening/closing states of the related valves to be affected by the valve set to be open and the opening/closing states of the related valves defined in the parameters 104b, and causes the notification processor 108 to notify the determination result.

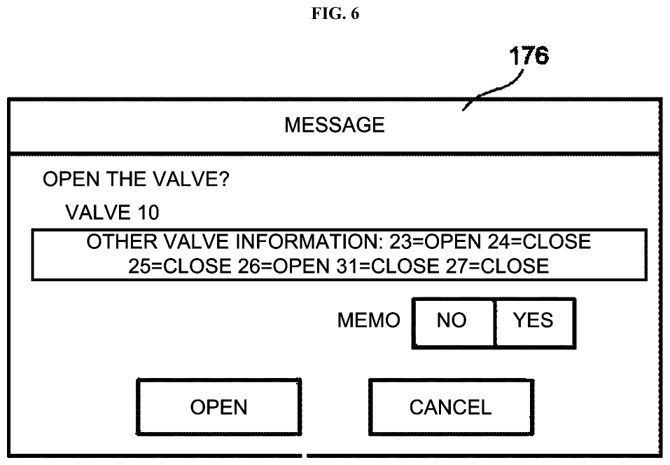

For example, when there is at least one of the related valves whose opening/closing states are different from the predefined opening/closing states corresponding thereto, the controller 101 may display a check area 176 (see FIG. 6) in the valve opening/closing setting area 175 to check (or confirm) whether to maintain the setting of the information thereof. In the check area 176, information on the valve which is set to be open and the related valves is displayed. In the example of FIG. 6, in the check area 176, a serial number or a name of the valve selected in the valve opening/closing setting area 175 and serial numbers or names of the entirety of the related valves to be affected by the valve selected in a manner described above are displayed. In addition, the check area 176 may include an area for selecting whether to maintain or cancel the opening/closing state of the valve set to be open. That is, the check area 176 is provided with: a button (“OPEN” shown in FIG. 6) for maintaining an opening setting of the valve; and a button (“CANCEL” shown in FIG. 6) for canceling the opening setting of the valve. According to the present embodiments, for example, when the button for maintaining the opening setting of the valve is selected (pressed) in the check area 176, the controller 101 switches the display of the valve set to be open in the valve opening/closing setting area 175. The contents displayed in the check area 176 are stored in the memory 104. Specifically, the contents displayed in the check area 176 may be automatically saved, or a “Save” button for executing a saving process may be provided. For example, when the button for canceling the opening setting of the valve is selected (pressed) in the check area 176, the controller 101 returns the state of the valve (which is set to be open in the valve opening/closing setting area 175) to a state when the state of the valve was set to be closed, or to a state before the state of the valve is set to be open.

For example, the controller 101 controls the event information area 71 to display the contents of the check area 176 stored in the memory 104.

For example, when there is no related valve whose opening/closing state is different from the predefined opening/closing state corresponding thereto, the controller 101 switches the display of the valve which is set to be open. In other words, when the opening/closing states of the related valves to be affected by the valve set to be open in the valve opening/closing setting area 175 are the same as the opening/closing states of the related valves defined in the parameters 104b, the controller 101 switches the display of the valve set to be open from a display of the closed state to a display of the open state.

For example, when there is at least one of the related valves whose opening/closing state is different from the predefined opening/closing state corresponding thereto, the controller 101 switches the display thereof to a display that differs in at least one among color, size, shape, line thickness and line type. In addition, the controller 101 may switch the display thereof to a blinking display.

As shown in FIG. 5, the valve opening/closing setting area 175 may be provided with a scroll bar serving as an operation area for performing an operation to scroll an image (display image) displayed in the valve opening/closing setting area 175 in at least one among an up-down direction (vertical direction) and a left-right direction (horizontal direction).

For example, when there is at least one of the related valves whose opening/closing state is different from the predefined opening/closing state corresponding thereto and the related valves are not displayed in the display image displayed in the valve opening/closing setting area 175, the controller 101 may scroll the display image within the valve opening/closing setting area 175 to display the related valves.

The valve opening/closing setting area 175 may be configured such that the image displayed in the valve opening/closing setting area 175 can be enlarged or reduced. In addition, as shown in FIG. 5, the valve opening/closing setting area 175 is provided with buttons for executing functions related to fixing, enlarging and reducing the image. By pressing such buttons, the display image can be fixed, enlarged or reduced. In the example of FIG. 5, a “Reduce” button is selected.

For example, when there are at least one of the related valves whose opening/closing state is different from the predefined opening/closing state corresponding thereto and the related valves are not displayed in the display image displayed in the valve opening/closing setting area 175, the controller 101 may reduce the display image within the valve opening/closing setting area 175 to display the related valves.

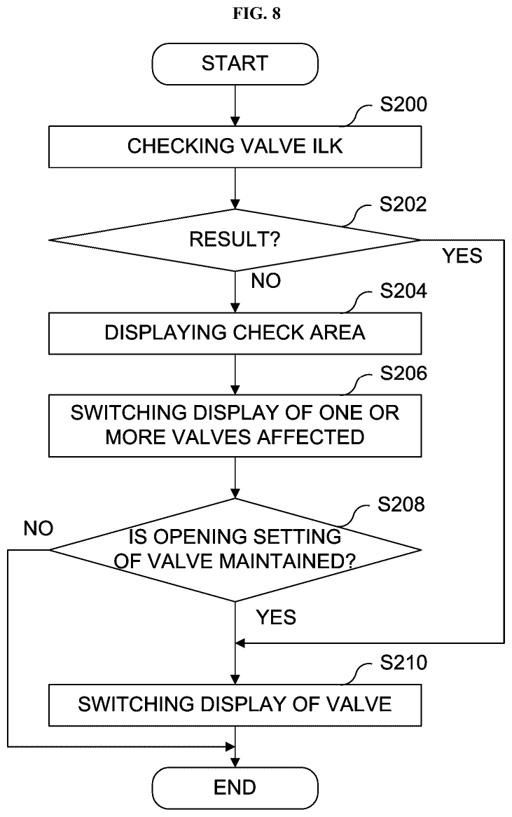

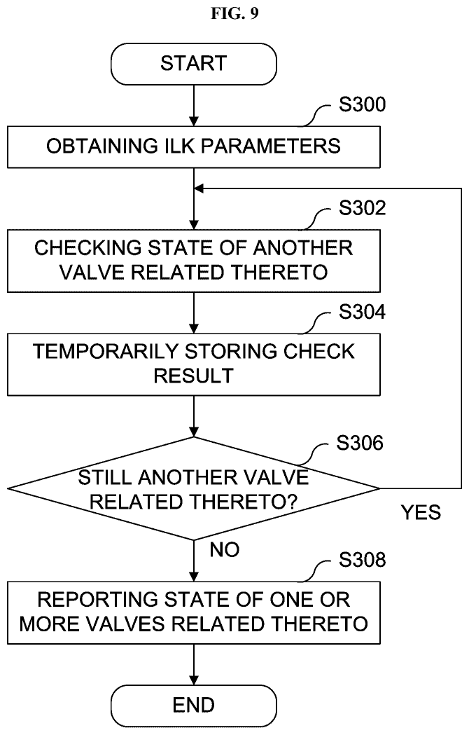

Subsequently, a valve setting flow of the substrate processing apparatus 1 according to the present embodiments will be described with reference to FIGS. 8 and 9. FIG. 8 is a flow chart schematically illustrating an example of a sequence of a valve opening/closing setting process, and FIG. 9 is a flow chart schematically illustrating an example of a sequence of the valve interlock check process (valve ILK check process). As an example, in the present embodiments, the valve interlock ILK check process shown in FIG. 9 is performed while the valve opening/closing setting process is being performed, that is, when a user sets the valve (which is in the closed state) to the open state.

First, when the valve is set to the open state in the valve opening/closing setting area 175, the valve opening/closing setting process is started.

In a step S200, the valve ILK check process shown in FIG. 9 is executed.

In a step S202, when a result of the valve ILK check process indicates that there is no difference between the opening/closing states of the related valves to be affected by the valve set to be open and the opening/closing states of the related valves defined in the parameters 104b, a step S210 is performed. On the other hand, there is any difference between the opening/closing states of the related valves to be affected by the valve set to be open and the opening/closing states of the related valves defined in the parameters 104b, a step S204 is performed.

In the step S204, the check area 176 is displayed on the valve opening/closing setting area 175.

In a step S206, the display of at least one of the related valves whose opening/closing state is different from the predefined opening/closing state corresponding thereto is switched.

In a step S208, when the opening setting of the valve is maintained, the step S210 is performed. On the other hand, when the opening setting of the valve is canceled, the valve opening/closing setting process is completed.

In the step S210, the display of the valve for which the opening setting is executed is switched to a display of the open state (see FIG. 7).

Subsequently, the valve ILK check process will be described.

In a step S300, the parameters 104b (see FIG. 10) that define the opening/closing state of another valve affected by the valve set to be open are read from the memory 104.

In a step S302, the opening/closing state of another valve affected by the valve set to be open is checked.

In a step S304, the opening/closing state of another valve checked in the step S302 is temporarily stored. For example, the opening/closing state of another valve checked in the step S302 may be temporarily stored in the memory 104 or the RAM 103.

In a step S306, it is determined whether there is still another valve to be affected by the valve set to be open. When there is no other valve to be affected by the valve set to be open, a step S308 is performed. On the other hand, when there is still another valve to be affected by the valve set to be open, the steps S302 to S304 are performed again with respect thereto.

In the step S308, the opening/closing states of the related valves to be affected by the valve set to be open are reported, and the valve ILK check process is terminated.

Subsequently, effects of the present embodiments will be described.

According to the present embodiments, when the valve is set to be open, by checking the states (that is the opening/closing states) of the related valves to be affected by the valve set to be open, it is possible to recognize the consistency of the opening/closing states of the related valves. In addition, by checking the consistency of the related valves in real time, it is possible to recognize the states of the related valves to be affected by the valve set to be open. As a result, it is possible to set the recipe without reducing an efficiency of the setting operation.

According to the present embodiments, by storing the parameters 104b in the memory 104, it is possible to maintain the information which is set even when the controller 101 is restarted.

According to the present embodiments, by defining, in the parameters 104b, the related valves to be affected by the valve set to be open, it is possible to identify (or specify) the related valves to be affected by the valve set to be open, and by checking the related valves identified in a manner described above, it is possible to save a valve checking time.

According to the present embodiments, by making the contents of the notification to be different therebeween depending on whether or not there is any difference between the opening/closing states of the related valves displayed in the valve opening/closing setting area 175 and the opening/closing states of the related valves defined in the parameters 104b, it is possible to reduce a load on the system due to an unnecessary processing or an unnecessary communication.

According to the present embodiments, even when more than one valves are to be affected by the valve set to be open, by notifying the result only once, it is possible to suppress a load on the processing of the apparatus or a communication load.

According to the present embodiments, by displaying the check area 176, it is possible for an operating personnel (worker) to recognize that there is any difference between the opening/closing states of the related valves displayed in the valve opening/closing setting area and those defined in the parameters 104b.

According to the present embodiments, by displaying the valve which is set to be open and the related valves to be affected by the valve set to be open in the check are 176, it is possible for the operating personnel to easily recognize the related valves to be affected by setting the valve to the open state.

According to the present embodiments, by storing the contents of the notification from the controller 101, even when the check area 176 is deactivated, for example, it is possible to check the contents of the notification later.

According to the present embodiments, by displaying, in the event information area 71, the contents of the notification from the controller 101 stored in the memory 104, even when the check area 176 is deactivated, for example, it is possible to check the contents of the notification later.

According to the present embodiments, even when the consistency of the related valves is not achieved, it is possible to perform the recipe setting operation without reducing the efficiency thereof by continuously performing the setting operation.

According to the present embodiments, by switching the display of the related valves according to the opening/closing states of the related valves, it is possible for the operating personnel to recognize the opening/closing states thereof.

According to the present embodiments, when the consistency of the related valves is achieved, the check area 176 is not displayed. Thereby, it is possible to prevent a decrease in a work efficiency.

According to the present embodiments, by switching the display of the related valves whose opening/closing state is different from the predefined opening/closing state corresponding thereto, it is possible for the operating personnel to clarify the related valves with the difference mentioned above, and it is also possible for the operating personnel to recognize incorrect settings for the related valves.

According to the present embodiments, by scrolling the screen, it is possible to check a piping configuration including an entirety of the valves.

According to the present embodiments, by automatically scrolling the screen, it is possible for the operating personnel to easily recognize the related valves whose opening/closing state is different from the predefined opening/closing state corresponding thereto.

According to the present embodiments, it is possible to check an entirety of the piping configuration on the screen, or it is possible to check an enlarged portion of the piping configuration.

According to the present embodiments, by automatically reducing the image displayed in the valve opening/closing setting area 175, it is possible for the operating personnel to easily recognize the related valves whose opening/closing state is different from the predefined opening/closing state corresponding thereto.

For example, the embodiments mentioned above are described by way of an example in which the substrate processing apparatus 1 is used. However, the technique of the present disclosure may also be applied to a program that causes a computer to perform the functions of the substrate processing apparatus 1. Further, the technique of the present disclosure may also be applied to a non-transitory computer-readable recording medium storing the program that causes the computer to perform the functions of the substrate processing apparatus 1.

In addition, the configuration of the substrate processing apparatus 1 described in the embodiments mentioned above is merely an example, and may be changed in accordance with circumstances without departing from the scope of the technique of the present disclosure.

In addition, the process flow of the program described in the embodiments mentioned above is merely an example, and may be changed. For example, an unnecessary step may be deleted, a new step may be added, or the process procedures may be changed without departing from the scope of the technique of the present disclosure.

For example, the embodiments mentioned above are described by way of an example in which the processing according to the embodiments is implemented by a software configuration that uses the computer to execute the program. However, the technique of the present disclosure is not limited thereto. For example, the technique of the present disclosure may also be applied to a hardware configuration capable of performing the processing, or may also be applied to a combination of hardware and software configurations capable of performing the processing.

For example, the embodiments mentioned above are described by way of an example in which a batch type substrate processing apparatus capable of simultaneously processing a plurality of substrates is used to form a film. However, the technique of the present disclosure is not limited thereto. For example, the technique of the present disclosure may also be preferably applied when a single wafer type substrate processing apparatus capable of processing one or several substrates at a time is used to form the film. In addition, the embodiments mentioned above are described by way of an example in which a substrate processing apparatus including a hot wall type process furnace is used to form the film. However, the technique of the present disclosure is not limited thereto. For example, the technique of the present disclosure may also be preferably applied when a substrate processing apparatus including a cold wall type process furnace is used to form the film.

The process procedures and the process conditions of each process using the substrate processing apparatuses exemplified above may be substantially the same as those of the embodiments mentioned above. Even in such a case, it is possible to obtain substantially the same effects as in the embodiments mentioned above.

As described above, according to some embodiments of the present disclosure, it is possible to recognize the consistency of the opening/closing states of one or more valves which are to be affected by a valve when the valve is set to be open.

What is claimed is:

1. A processing system comprising
a display structure provided with a display area in which a recipe defining process conditions for a substrate is editable, wherein the display area comprises a valve opening/closing setting area configured to set opening/closing states of a plurality of valves connected to a piping through which a fluid used in processing the substrate flows; and
a controller configured to be capable of:
(a) when at least one specified valve among the plurality of valves is set to be open, checking opening/closing states of one or more related valves among the plurality of valves which are to be affected by the specified valve set to be open; and
(b) when the opening/closing states of the related valves are different from predefined opening/closing states, switching a display of each related valve whose opening/closing state is different from a corresponding one of the predefined opening/closing states in the valve opening/closing setting area.

2. The processing system of claim 1, further comprising
a memory configured to store parameters defining the opening/closing state of the specified valve set to be open and the opening/closing states of the related valves affected by the specified valve set to be open,
wherein the controller is further configured to be capable of:
(c) obtaining the parameters from the memory when the specified valve is set to be open; and
(d) determining a difference between the opening/closing states of the related valves displayed in the valve opening/closing setting area and the opening/closing states of the related valves defined in the parameters.

3. The processing system of claim 2, wherein each of the opening/closing states of the related valves is defined in the parameters.

4. The processing system of claim 2, wherein the controller is further configured to be capable of
(e) notifying a result determined in (d).

5. The processing system of claim 4, wherein, in (e), the result determined in (d) is notified after determining a difference between the opening/closing states of the related valves affected by the specified valve set to be open and opening/closing states of the related valves defined in the parameters.

6. The processing system of claim 4, wherein the controller is further configured to be capable of
(f) when it is determined that there is at least one of the related valves whose opening/closing state is different from that defined in the parameters, activating a display of a check area in the valve opening/closing setting area to check whether to maintain a designated state thereof.

7. The processing system of claim 6, wherein information on each of the specified valve set to be open and the related valves is displayed in the check area.

8. The processing system of claim 6, wherein the memory is further configured to store contents to be displayed in the check area.

9. The processing system of claim 6, wherein the check area is provided with an area configured to select whether to maintain or cancel the opening/closing state of the specified valve set to be open.

10. The processing system of claim 9, wherein the controller is further configured to be capable of switching a display of the specified valve set to be open in the valve opening/closing setting area when it is selected in the check area to maintain the opening/closing state thereof.

11. The processing system of claim 4, wherein the controller is further configured to be capable of, when it is determined that there is no related valve whose opening/closing state is different from that defined in the parameters, switching a display of the specified valve set to be open.

12. The processing system of claim 4, wherein the controller is further configured to be capable of, when it is determined that there is at least one of the related valves whose opening/closing state is different from that defined in the parameters, switching the display of the at least one of the related valves by changing at least one of color, size, shape, line thickness or line type thereof.

13. The processing system of claim 1, wherein the valve opening/closing setting area is provided with an operation area configured to perform an operation to scroll a display image displayed in the valve opening/closing setting area along at least one of an up-down direction or a left-right direction.

14. The processing system of claim 13, wherein the controller is further configured to be capable of, when there is at least one of the related valves whose opening/closing state is different from that defined in the parameters but which is not displayed in the valve opening/closing setting area, scrolling the display image so that the at least one of the related valves is displayed in the valve opening/closing setting area.

15. The processing system of claim 1, wherein it is possible for a display image displayed in the valve opening/closing setting area to be enlarged or reduced in the valve opening/closing setting area.

16. The processing system of claim 15, wherein the controller is further configured to be capable of, when there is at least one of the related valves whose opening/closing state is different from that defined in the parameters but which is not displayed in the valve opening/closing setting area, reducing a size of the display image so that the at least one of the related valves is displayed in the valve opening/closing setting area.

17. A substrate processing apparatus comprising:
a process vessel in which the substrate is processed;
a display structure provided with a display area in which a recipe defining process conditions for a substrate is editable, wherein the display area comprises an valve opening/closing setting area configured to set opening/closing states of a plurality of valves connected to a piping through which a fluid used in processing the substrate flows; and
a controller configured to be capable of:
(a) when at least one specified valve among the plurality of valves is set to be open, checking opening/closing states of one or more related valves among the plurality of valves which are to be affected by the specified valve set to be open; and
(b) when the opening/closing states of the related valves are different from predefined opening/closing states, switching a display of each related valve whose opening/closing state is different from a corresponding one of the predefined opening/closing states in the valve opening/closing setting area,
wherein the controller is further configured to be capable of performing a control such that the substrate is processed by using the recipe edited.

18. A processing method comprising:
(a) displaying an editable display area in which a recipe defining process conditions for a substrate is editable, wherein the display area comprises a valve opening/closing setting area configured to set opening/closing states of a plurality of valves connected to a piping through which a fluid used in processing the substrate flows;
(b) editing the recipe; and
(c) when at least one specified valve among the plurality of valves is set to be open, checking opening/closing states of one or more related valves among the plurality of valves which are to be affected by the specified valve set to be open, and when the opening/closing states of the related valves are different from predefined opening/closing states, switching a display of each related valve whose opening/closing state is different from a corresponding one of the predefined opening/closing states in the valve opening/closing setting area.

19. A method of manufacturing a semiconductor device, comprising:
(a) editing a recipe in which process conditions for a substrate are defined; and
(b) processing the substrate by the substrate processing apparatus of claim 17 using the recipe edited in (a).

20. A non-transitory computer-readable recording medium storing a program that causes the substrate processing apparatus of claim 17, by a computer, to perform:
(a) editing the recipe in which the process conditions for the substrate are defined; and
(b) processing the substrate using the recipe edited in (a).
